(19) United States
(12) Patent Application Publication
(10) Pub. No.: US 2006/0212356 A1
(43) Pub. Date: Sep. 21, 2006

(54) System and method for integrated order and channel management

(76) Inventors: Michael Lambert, Miramar, FL (US); David J. Nepo, Miami, FL (US)

Correspondence Address: BROWN, RAYSMAN, MILLSTEIN, FELDER & STEINER LLP, 900 THIRD AVENUE, NEW YORK, NY, 10022, US

(21) Appl. No.: 11/376,732

(22) Filed: Mar. 14, 2006

Related U.S. Application Data
(60) Provisional application No. 60/662,136, filed on Mar. 14, 2005.

(51) Int. Cl. G06Q 20/00

(52) U.S. Cl. 705/16

(57) ABSTRACT

Order management comprises receiving, over a data network, one or more orders for associated products from one or more customers for storage in a data store and selecting a given order from a given customer to a merchant from among the received one or more orders. Status codes are set for the given order as well as one or more items associated with the given order. The product associated with the given order is provided to the given customer on the basis of the status code. Channel management comprises determining product information for inclusion in a channel feed to the electronic distribution channel and determining one or more characteristics for the channel feed. The channel feed is generated for the product on the basis of the one or more characteristics and a determination is made as to when to transmit the channel feed to the electronic distribution channel.

The present invention claims the benefit of U.S. Provisional Patent Application No. 60/662,136, entitled “System and method for integrated order and channel management,” filed on Mar. 14, 2005, attorney docket no. 7163/1PROV, the disclosure of which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

In the past, a merchant would typically stock a certain amount of inventory on showroom shelves, maintaining secondary stock within a warehouse if available. Point of Sale software that the merchant utilizes would help keep track of sales and inventory counts, noting when reorders would be necessary because certain minimum stock counts had been reached. This would cause the merchant to place a purchase order with the appropriate vendors, who would then ship one or more products to the merchant with the hope of reaching the merchant's facility before the remaining stock was completely depleted. Online retail processes, however, are significantly different, as are the customers and merchants that employ online retail systems. For example, with online merchants, there is often no inventory whatsoever.

Even though the total number of customers is rapidly growing, customers maintain a certain amount of trepidation when conducting online purchases. Customer reluctance to conduct online transactions often stands in the way of an online merchant reaching projected sales goals. In an attempt to ease customer fears, the largest online entities, such as Yahoo! and eBay, have created systems whereby individual users rate merchants selling goods online through their respective sites. Ratings for each merchant are easily viewable by any consumer. Therefore, where a consumer is unsure of whether they wish to purchase goods or services from any particular merchant, they may review that merchant's performance in dealing with other consumers. Accordingly, customer satisfaction has become one component of online retail success.

Other than fraudulent retailers, the majority of bad reviews for online retailers come from delayed shipments or poor customer service. The failure of existing systems and methods to employ a single repository of information for a customer, merchant and vendor prevents the timely updating of information regarding orders that customers are placing with a merchant, which the merchant may then supply to the customer. Furthermore, there are no techniques for seamlessly reporting any vendor delay to customers, or to reroute a particular purchase order to another vendor in the event of a delay or other issues involved in fulfilling an order.

Advertising is another challenge for merchants in the online retail marketplace. Before online retail, merchants placed advertisements in magazines, on television and other media sources with information regarding the merchant, or perhaps a featured product that the merchant is retailing. These advertisements were designed to drive the customers to the merchant's facility where they might shop and see products that would trigger a purchase. The utility of many forms of marketing, however, as well as the protocols and procedures, have changed with the proliferation of online retail.

Many successful online merchants place their entire product catalog in virtual shopping environments using product aggregation systems, which may be referred to as “channels.” Consumers use these channels as product search systems, such as when conducting price comparisons of similar products from competing merchants, as well as providing a one stop environment to conduct research and identify the best products at the best price point. Once the consumer has located their preferred merchant, these systems provide the customer the ability to directly access the chosen online merchant's virtual storefront, which typically utilize an electronic shopping cart for the completion of purchases. The channels that provide these services are paid for each customer that clicks a link to arrive at the online merchant's storefront whether a purchase occurs or not. Many current systems and methods for providing information to a given channel, however, fail to provide flexibility in data formatting and the use of available communication protocols to allow a merchant's most current data to be provided to one or more channels. Furthermore, the shortcomings in existing systems potentially result in merchants paying for the presentation of outdated product information, as well as for clicks to products that are no longer available.

Thus, there is a need for systems and methods that allow for integrated order and channel management, providing seamless interaction between customers, merchants and vendors, which overcome the shortcomings of existing systems and methods.

### SUMMARY OF THE INVENTION

The present invention is directed towards systems and methods for order and channel management, including integrated order and channel management. According to one embodiment, the present invention is directed towards a method for managing an order for a product from a customer in a computerized order management system. According to one embodiment, the method comprises receiving, over a data network, one or more orders for associated products from one or more customers for storage in a data store. A given order from a given customer to a merchant is selected from among the received one or more orders and status codes are set for the given order, as well as for one or more items associated with the given order. The product associated with the given order is provided to the given customer on the basis of the status code, which may include shipping or otherwise transmitting the product to the customer. An integrated order and channel management system may receive the one or more orders over the data network, which may be the Internet or any combination of local and wide area networks.

The method of order management, according to embodiments of the invention, includes applying a merchant created filter and presenting one or more orders from the data store that satisfy the filter. A third party other than a merchant may also create filters. The order management system may also receive one or more updates to a given order in the data store by a vendor of the associated product for storage as an update to the given order in the data store. The updated information is presented to the merchant. A merchant or customer may also perform one or more actions resulting in the update of a given order. The method may further include generating, by the merchant, a communication to a customer that placed the given order with regard to the update, which is transmitted to the customer. Generating the communication may also be handled in an automated manner, e.g., according to a schedule or frequency.

Orders and items may have associated status codes. Setting the status code for one or more items may comprise setting on the basis of the status code of the order with which the one or more items are associated. Alternatively, setting the status code for one or more items comprises setting independent of the status code of the order with which the one or more items are associated. The status code may further be set on the basis of an order score. According to one embodiment, determining the order score comprises retrieving a score calculation data structure comprising one or more score criterion and determining, for the one or more score criterion in the score calculation data structure, the presence of a given score criterion in the given order. The order score may be increased on the basis of the presence of the one or more score criterion in the given order.

In addition to the foregoing, the present invention is directed to systems and methods for channel management, which may include integrated order and channel management. According to one embodiment, the invention is directed towards a method for managing a product data feed for delivery to an electronic distribution channel. According to one embodiment, the method comprises determining product information for inclusion in a channel feed to the electronic distribution channel and determining one or more characteristics for the channel feed. The channel feed is generated for the product on the basis of the one or more characteristics for the channel feed and a determination is made as to when to transmit the channel feed to the electronic distribution channel.

Determining the one or more characteristics of the channel feed may comprise determining a protocol for transmission of the channel feed, e.g., the file transfer protocol (“FTP”). Determining the one or more characteristics may also comprise determining file format for transmission of the channel feed and a destination for transmission of the channel feed, e.g., an electronic distribution channel such as Froogle or MySimon. The method may further comprise transmitting the channel feed to the electronic distribution channel according to the one or more characteristics. According to various embodiments of the invention, transmitting the channel feed comprises transmitting according to a frequency, according to a schedule, according to a merchant transmission signal, or combinations thereof.

In generating the channel feed, an XML file may be generated for the product on the basis of the one or more characteristics; the XML file identifying the product and the one or more characteristics. Generating the channel feed may also comprise querying a data store to retrieve the product information and the one or more characteristics. According to certain embodiments, the generated channel feed is compressed.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a configuration of components for an integrated order and channel management system according to one embodiment of the present invention;

FIG. 2 is a flow diagram presenting a method for order management review according to one embodiment of the present invention;

FIG. 3 is a screen illustration presenting an interactive screening report interface according to one embodiment of the present invention;

FIG. 4 is a flow diagram presenting a method for order scoring according to one embodiment of the present invention;

FIG. 5 is a flow diagram presenting a method for automatic transmission of order updates according to one embodiment of the present invention;

FIG. 6 is a flow diagram presenting a method for inbound and outbound communications management according to one embodiment of the present invention;

FIG. 7 is a flow diagram presenting a method for automated channel management according to one embodiment of the present invention;

FIG. 8 is a screen illustration presenting an interface for interacting with existing channel feeds according to one embodiment of the present invention;

FIG. 9 is a screen illustration presenting a channel feed information interface according to one embodiment of the present invention;

FIG. 10 is a screen illustration presenting a channel feed data interface according to one embodiment of the present invention;

FIG. 11 is a screen illustration presenting a channel feed transport interface according to one embodiment of the present invention;

FIG. 12 is a screen illustration presenting a channel feed log interface according to one embodiment of the present invention; and

FIG. 13 is a screen illustration presenting an interface to specific order and channel management functions of the IOCM system according to one embodiment of the present invention.

### DETAILED DESCRIPTION OF THE INVENTION

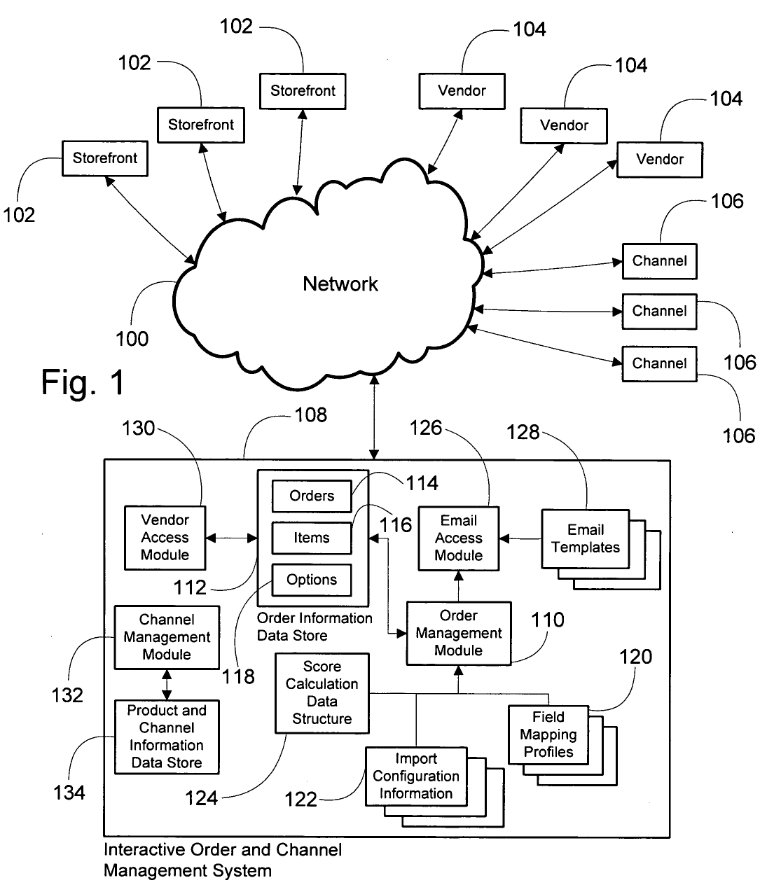

With reference to FIGS. 1 through 13, detailed embodiments of the present invention are now described. Referring to FIG. 1, order management according to systems and methods of the present invention support orders placed directly within the order management module 110 of the integrated order and channel management (“IOCM”) system 108. The IOCM may also import orders according to a number of standardized formats from online storefronts 102, shopping carts or other electronic commerce systems that are in communication over a network 100, e.g., the Internet. To this end, each order coming into the order management module 110 may be tagged with data indicating the original source from which the order arrived. Accordingly, the order management module 110 is configured to identify each potential source from which orders may potentially arrive into the IOCM system 108.

According to one embodiment of the invention, a merchant configures the order management module 110 with information regarding order sources via a “storefronts” interface that the system 108 provides to the merchant. Once an order has been placed, either directly within the system or imported from any number of external systems, e.g., one or more electronic storefronts 102, the order management module 110 stores information related to the order in an order information data store 112, which advantageously aids in customer service, customer communications, and vendor communications. The information contained within the IOCM system 108 may also be used for reporting and various other tasks that are ancillary to order management.

Orders in the order information data store 112 may contain three levels of data, which according to embodiments of the invention are related: information regarding the order itself 114, information regarding items 114 within the order, and information regarding options 118 related to a given item within the order. Accordingly, the IOCM system 108 comprises an order information data store 112 for storage, management and maintenance of these data, 114, 116 and 118. According to one embodiment of the invention, the order information data store 112 is a relational database that contains one or more tables, for example, orders 114, items 116 and options 118 tables. Data in the orders table 114 may comprise a one-to-many relation with data in the items table 116, and data in the items 116 table may comprise a zero-to-many relation with data in the options table 118. As such, a given order is related to one or more items, and each item in an order is related to one or more options regarding the item. It should be apparent to one of skill in the art that the IOCM system 108 is not limited to the use of relational databases and may utilize any data store capable of providing structured storage of data, including, but not limited to, comma separated values files, tab delimited data files, XML data files, a relational database, an object-oriented database, a hybrid relational/object database, or other standard formats known to those of skill in the art.

Regardless of the format used to store orders and related information, the order management module 110 receives incoming information from storefronts 102 that it maps to the one or more data tables within the system 108. Mapping allows the order management module 110 to interface with incoming information formatted according to a number of disparate formats that are utilized by various electronic storefronts 102 providing information to the IOCM system 108, as each storefront 102 may transmit order information according to disparate formats and organizational structures, including, but not limited to, CSV information, tab delimited information, XML information, etc. There may be a different field mapping profile 120 for each storefront 102 providing information to the IOCM system 108. Alternatively, all storefronts 102 may share one field mapping profile 120. To this end, the IOCM system 108 may maintain the field mapping profiles 120 in a data store that allows the merchant to specify and maintain the mapping profile or profiles, which may be the same data store that stores order information.

An association between fields in a given order and order information in the order information data store 112 is accomplished by using a field mapping profile 120. For example, the association may identify that the “order number” field according to information from “storefront A” is written to an ORDER_ID field within the data store that the IOCM system uses to maintain orders. The field mapping profile 120 maps fields from incoming order information with the particular data structures in the order information data store 112 that the IOCM system 108 uses to maintain the order information. Upon receipt of order information, the order management module 110 selects a mapping 120 to use to import the incoming order information into the order information data store 112.

According to various embodiments of the invention, there are a number of techniques for selecting information to import into the IOCM system 108. A first technique involves the merchant individually selecting orders from one or more storefronts 102 to import into the IOCM system 108. For example, a merchant may access a given storefront 102 and import one or more order files, item files and option files. Alternatively, the order management module 110 provides for “auto-import” of information from storefronts 102 by accessing a plurality of storefronts 102 in an automated fashion, which eliminates the need to manually import the information. For example, a merchant may create configuration information 122 identifying address and access information for each of one or more storefronts 102 and, for each storefront 102, identify a field mapping profile 120 to use when importing information from a given storefront 102.

When the merchant issues an import command, e.g., selection of a graphical control that the order management module 110 presents or according to a timed event, the order management module 110 accesses a storefront 102 and imports the order information into the order information data store 112. The order management module 110 may optionally present the merchant with a preview of the incoming information for evaluation prior to storage in the order information data store 112. Where the information appears to be incorrect, the merchant may abandon the importation of the incoming information.

As indicated above, automatically importing information into the IOCM system 108 may be initiated according to a merchant command or a timed event. When using a timed event, the order management module 110 accesses storefronts 102 either according to a set schedule, e.g., every night a 11:00 PM, or a frequency, e.g., every twenty minutes. Upon the occurrence of the timed event, the order management module 110 accesses a given storefront 102 and retrieves order information for storage in the order information data store 112. For example, a storefront 102 may support an XML or XSDL location that allows retrieval of information in such a manner.

Regardless of the technique that the system employs to retrieve information from the various storefronts 102, the order management module 110 may operate according to a batch mode to process the incoming information. The order management module imports information and creates purchase order identifiers for orders that it imports. According to one embodiment, the order management module 110 creates the purchase order identifier by placing a three character storefront code in front of the order number, which is then followed by a four-character vendor code. This methodology insures that all products from one order going to one vendor 104 maintain a unique identifier, even where there are items within the order that a secondary vendor may provide.

The order management module 110 is also operative to create purchase orders and initially screens the purchase orders. As is explained in greater detail herein, the order management module 110 may designate a given order as valid, fraudulent, on hold, or other classifications as are known to those of skill in the art. Appendix A presents an exemplary table that the IOCM system 108 may use to maintain order information. Orders that are not being held as problematic, e.g., potentially fraudulent, are identified as valid for shipment, which notifies drop ship vendors 104 that there are orders available to ship. The IOCM system 108 allows these vendors 104 access to information necessary for order fulfillment through a vendor access module 130, which is described in greater detail herein.

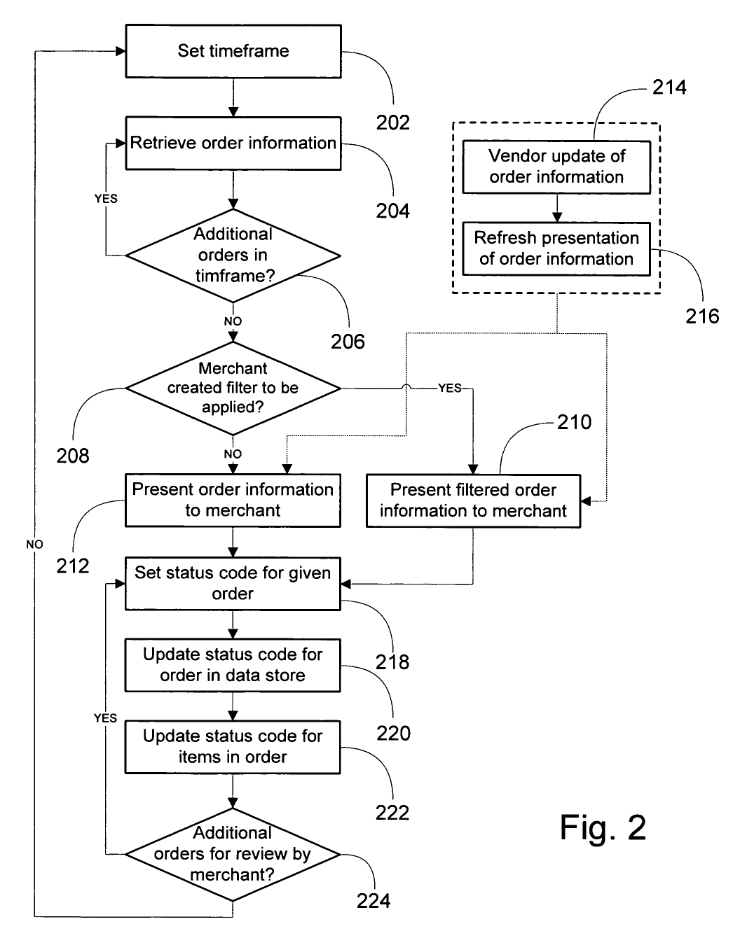

Order screening is the process by which the order management module reviews orders for security and validity, setting a status code for a given order (e.g., a cancel code) and marking the order as processed. According to embodiments of the invention, the screening process illustrated at FIG. 2 is driven by a merchant through use of an interactive screening report interface that the order management module provides. The interactive screening report interface presents outstanding orders to the merchant between a given date range or timeframe, step 202, e.g., purchase orders with the current date. The order information is retrieved, step 204, and a check is performed to determine if additional orders are in the data store for the given timeframe, step 206. The loop repeats until all orders in the given timeframe are retrieved, steps 206 and 206.

A check is performed to determine if the merchant has created any filters to be applied to the retrieved orders, step 208. According to one embodiment, the interface provides filters that allow the merchant to view a subset of outstanding orders, causing the orders that the interface displays to change. Filters may be of an appropriate structure to work with the data store from which the order information is to be retrieved. For example, where order information is in a SQL database, the filters may comprise properly formatted SQL statement to retrieve filtered order information. Where no filter is to be applied, step 208, the interface presents the order information to the merchant, step 212. Alternatively, filtered order information is presented to the merchant, step 210. Using the interface, the merchant may modify a given order to set the status code for the given order, which the merchant may select from a drop down list. The interface may also allow the merchant to modify other information regarding a given order, e.g., the date of the order. In order to determine the security and validity of each order, the order management module assigns each order a rating, or score, which may be dynamically created according to techniques discussed in greater detail herein.

For a given order, the order management module evaluates the order's score to determine if the order is problematic and should thus not proceed to shipping, e.g., where the order's score crosses an acceptable threshold. The order management module marks the status of those orders with unacceptable scores as fraudulent and writes other orders as valid for shipment during the posting process, step 218. The status code for the given order is updated in the data store, step 220. The status code for each item in the order is updated as well, step 222. By changing the status, the information regarding the order in the order information data store is updated, and may drop off of the interface at that point. For example, if the merchant is viewing purchase orders for the current day where status codes have not been set, and the status code for a given order is changed to “fraud,” e.g., based on the score of the order, the interface no longer presents information for that order. Furthermore, according to one embodiment the status code for all items contained in the order is also set to “fraud.” The merchant is still capable of finding the order information again by searching the order information data store for all orders with the status code set to “fraud.”

The order management module performs a check, step 224, to determine if additional orders are present for review. Where additional orders are present, step 224, processing returns to step 218 where the status code is set for a subsequent order. Where no additional orders are present, step 224, orders for a subsequent timeframe are processed, step 202.

The merchant may also use the interface to view vendor interaction with the IOCM system. As vendors update order information in the order information data store through the use of a vendor access module, step 214, which is explained in greater detail herein, the interface presents the updated order information when it performs a refresh, step 216. For example, assume that a merchant is viewing all purchase orders for the current day and the vendor acknowledges receipt of a given order through the vendor access module. When the interface refreshes the data that it is displaying, the interface displays the updated information that the vendor has made to the given piece of information. At this point, the merchant may decide to charge the order, such as using a credit card terminal or other back office tools known to those of skill in the art, noting in the data store that the order has been charged. According to some embodiments, the interface displays a vendor acknowledgement only after all items within a given order have been acknowledged.

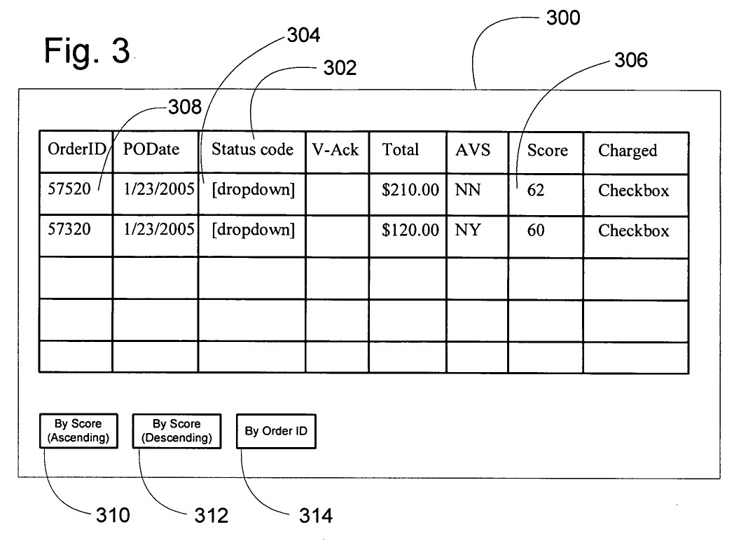

FIG. 3 presents one embodiment of an interactive screening report interface that the order management module provides. The status code 302 within the interface 300 is a drop down selector 304. When the merchant selects a new status code for a given order, the order management module records the change in information regarding the order in the order information data store, as well as information regarding items within the order. If the merchant clicks on the score field 306 for a given one of the orders, a pop up window shows the criteria that were met for the order in calculating the score. The window may show the text from the invoice involved in the score and the impact value. Scoring is described in greater detail below. Furthermore, it should be apparent to one of skill in the art that the interface is not limited to the use of a pop up window and that other interfaces for presenting the score information for a given order are contemplated as falling within the scope of the invention.

Similar to the score pop up window, the interface also provides an order pop up window that the interface displays in reaction to the merchant selecting the order identifier field 208 of a given order. Where the merchant selects the order identifier 308, the interface displays an order screen pop up window that displays order information. This pop up window provides a read only interface providing order information including, but not limited to, customer billto and shipto information, credit card information, and information regarding each item within the order. The interface also provides sorting controls that allow the merchant to adjust the display order that the interface 300 utilizes: By Score (Ascending) 310, By Score (Descending) 312 and By Order ID 314.

As discussed above, where the merchant selects the score field from the interface, the system may present a pop up window or similar interface to the merchant that shows each condition and its associated score that the order satisfied in generating the score. Table 1 presents an exemplary set of data that the pop up window may present for a given order:

TABLE 1

| | |
|---|---|
| Non US Country | 10 |
| Bad CC Address | 7 |
| Bad CC Zip | 8 |
| Etc . . . | |
| Total | 62 |

According to the exemplary information of table 1, because the country field on the order was not U.S., and the address verification system (“AVS”) reported from an outside source, e.g., Yahoo!, shows that the credit card address and credit card zip code that were provided by the customer are incorrect according to the card issuer, the system calculates a total score of 62 for the given record. This pop up window shows the merchant how and why the system calculated a given score, which may drive decisions regarding the processing of an order, e.g., where a score exceeds a threshold the system marks the order as fraudulent and cancels further processing.

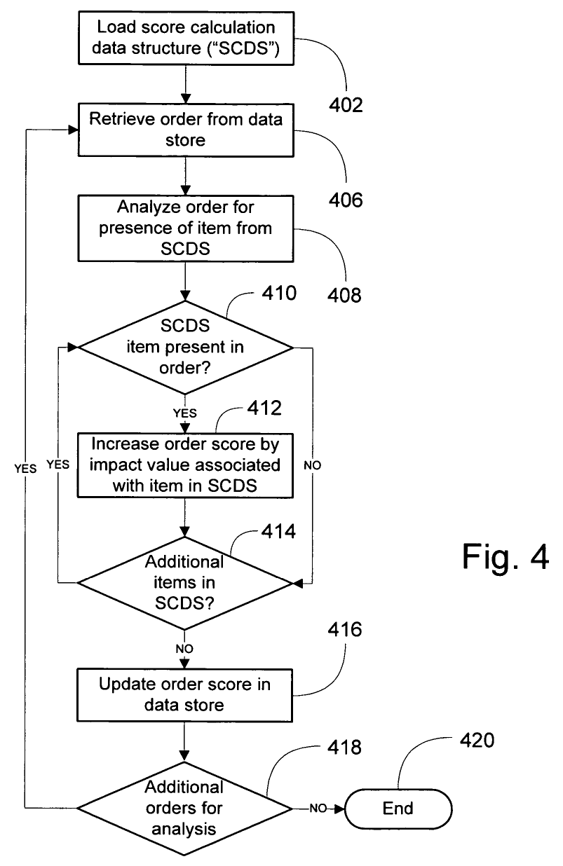

As discussed above, the scoring techniques of the present invention allow the order management module to more quickly and accurately screen the orders. FIG. 4 illustrates one embodiment of a scoring technique. Scoring is accomplished through the use of dynamic “grading” or scoring of each order in terms of possible fraud. Based on information regarding an order, the order management module calculates the chance that a particular order is fraudulent. According to one embodiment, this does not mean the order is necessarily a fraud, but simply that the order displays characteristics that could indicate the possibility of fraud. The score for each order is based on score criterion located in a score calculation data structure, which the order management module may load for use in processing, step 402. Appendix B presents an exemplary score calculation data structure for use with embodiments of the present invention.

The order management module retrieves a given order from the data store, step 406, and analyzes the order for the presence of each item that the data structure contains by traversing the score calculation data structure, step 408. A check is performed to determine if a given item from the score calculation data structure is present in the order, step 410. When the system identifies a condition in an order that is in the score calculation data structure, it refers to the impact field within the data structure to determine the value that it should add to the overall score for the order, step 412. A check is performed to determine if there are additional items in the score calculation data structure that require evaluation, step 414. The system repeats this evaluation until it has considered all conditions in the data structure, steps 410 through 414, respectively. For example, if an order contains a billing name that differs from the shipping name, the system may increase the score by 3. Similarly, if the Order Time is between midnight and 5 AM, the system may increase the score by 2.

After the system evaluates an order according to each condition within the data structure, the total sum is the “score” for an order, which the order management module may show to the merchant through the interface of FIG. 3. A check is performed to determine if additional orders require analysis, step 418. Where additional orders are present, processing returns to step 406 where a subsequent order is scored by the system. The method terminates where no additional orders are present for processing, step 420.

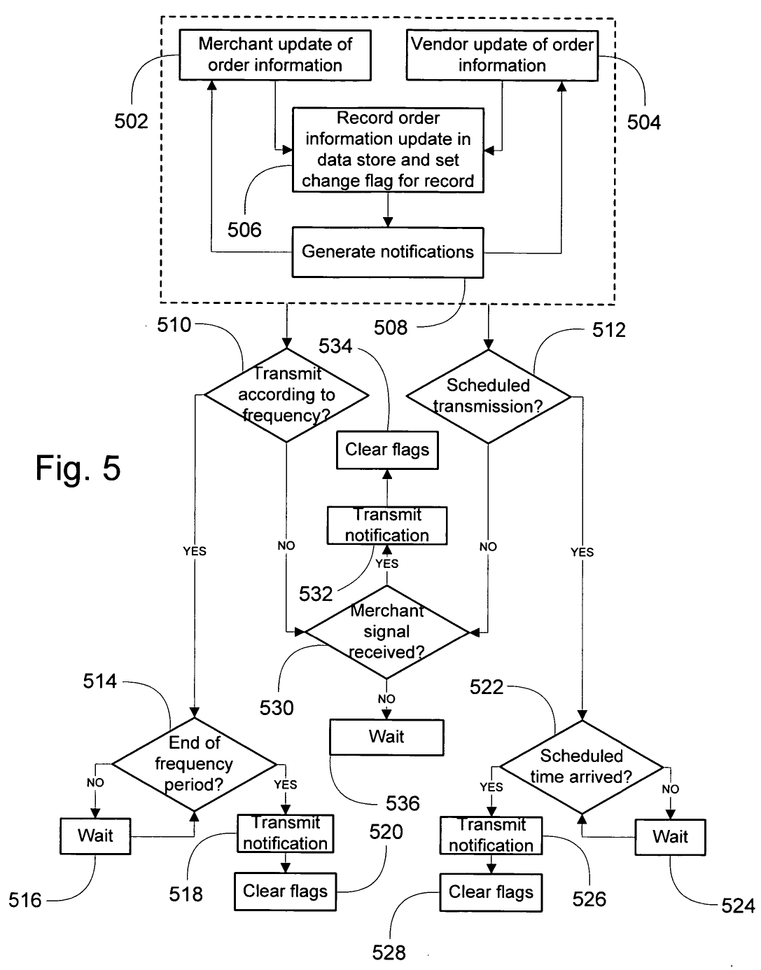

An advantage of utilizing the IOCM system is that the order management module allows for the automated transmission of regular updates to a customer by flagging all changes to information within the system as illustrated in FIG. 5. Both merchants and vendors have access to order information in the data store and may synchronously update the information contained therein, steps 502 and 504. Any time a piece of information from an order is modified, regardless of whether by the merchant, the IOCM system or a vendor, the system records the order information updates and flags the information as changed information, step 506. The IOCM system generates notifications based on the presence of flags and using the updated order information, in addition to other information in the data store, step 508.

On a periodic basis, which may be according to a schedule, step 512, a frequency, step 510, or a merchant transmission signal, step 530, the order management module collects the changed information for each order, which may be identified by flags, and sends a notification to the customer indicating the change. The transmission of the notification may be according to a frequency, step 510, which causes the order management module to check for the end of the frequency period, step 514. Where the frequency period has not ended, the system enters a wait state, step 516, and continues to check for the end of the frequency period, step 514. When the frequency period ends, the order management module sends one or more notifications to customers on the basis of flagged information within the orders (indicating updated order information), step 518. The flags are cleared, step 520, indicating that the system has sent the updated information to the customer.

Alternatively, or in conjunction with transmitting according to a frequency, the transmission of the notification may be sent according to a schedule, step 512, which causes the order management module to check for the occurrence of the scheduled time, step 522. It should be noted to those of skill in the art that a schedule and schedule time may be set according to any combination of date and time including, but not limited to, day of the week, every day at a specified time, on a given day of the month, etc. According to one embodiment, the order management module is running in a UNIX environment and may utilize the “cron” tool to schedule a signal to the system to generate the notifications. Similarly, in a Microsoft Windows environment, the merchant may set a Microsoft scheduled event to signal the generation of the notifications.

Where the scheduled time has not arrived, the system enters a wait state, step 524, and continues to check for the arrival of the scheduled time, step 522. When the scheduled time arrives, the order management module sends one or more notifications to customers on the basis of flagged information within the orders (indicating updated order information), step 526. The flags are cleared, step 528, indicating that the system has sent the updated information to the customer.

The merchant may also manually signal transmission of the one or more notifications, step 530. Where the merchant has not set a schedule or frequency by which to transmit notifications, and a merchant transmission signal is not received, step 530, the system enters a wait state, step 536, until the occurrence of a frequency, step 510, scheduled time, step 512, or merchant transmission signal, step 530. When the order management module receives the merchant transmission signal, step 530, one or more notifications are sent to one or more customers, step 532. The flags are cleared, step 534, indicating that the system has sent the updated information to the customer.

The following are exemplary illustrations of the process of generating and transmitting customer notifications in response to changes in the customer's order. The order management module imports and screens order information from one or more storefronts over a computer network, such as the Internet, and generates purchase orders. As is explained in greater detail herein, a vendor accesses the order management module and acknowledges a purchase order, causing the system to flag the order as containing updated information regarding shipment of the order. At a specified time, or according to a frequency, the order management module generates a notification that it transmits over the network to the customer. The notification may include the updated information and any other text that the order management module is configured to include with the communication.

Continuing with the above example, assume that the next day the drop ship vendor accesses the vendor access module to update the order with tracking number information, which also causes the generation of a flag on the order. At a specified time, or according to a frequency, the order management module generates another notification that it transmits over the network to the customer. The notification may include the updated information and any other text that the merchant configures the order management module to include with the communication.

Turning to an alternative example, where a drop ship vendor or customer service representative updates an order to indicate that a product is on back order, the order management module flags the order as containing updated information regarding the status of the order. At a specified time, the order management module generates a notification that it transmits over the network to the customer noting that the ordered product is on back order. The notification may also include other information, such as a time at which the order is to be shipped, which is taken from updated information supplied by a vendor or merchant. Similarly, where an order is updated to reflect that an item is discontinued, the order management module flags the order as containing updated information regarding the status of the order. At a specified time, the IOCM system generates a notification that it transmits over the network to the customer noting that the ordered product is discontinued. The notification may also include other information, such as noting that the particular item will not ship as it is no longer available and that the credit card will not be charged, or will be refunded, etc.

Where the order management module cannot process an order due to irregularities, e.g., credit card fraud, the order status is updated and set to “on hold,” causing the order management module to set a flag on the order. At a specified time, the order management module generates a notification that it transmits over the network to the customer noting that there is an issue with the order. The notification may also include other information, such as noting that the customer should contact a customer support representative.

According to one embodiment of the invention, the order management module uses email to transmit notifications to customers. Returning to FIG. 1, the IOCM system comprises an email access module 126 that imports communications and generates the notifications. The email access module 126 provides an interface that allows the merchant to create one or more templates 128 for a variety of situations that require a notification to be sent to a customer. Advantageously, the templates 128 may use information from the order information data store 112, e.g., field names from a relational database, which are dynamically populated with information from the data store when the email access module 126 generates the email notifications. For example, assume that a template 128 contains a reference to the “customer name” field from the data store. When the order management module 110 instructs the email access module 126 to generate an email, the module 126 dynamically replaces the reference in the template 128 to “customer name” with the name of the customer associated with the order. The email access module 126 may dynamically insert any information in the order information data store 112 into an email template 128 at runtime. Appendix C contains an exemplary table structure for orders, items and options that the system maintains in a relational database. The merchant may utilize any field in the email templates for customer communications.

In addition to aggregating orders from a number of storefronts and other electronic commerce systems, the IOCM system 108 provides for end-to-end order management by integrating vendors 104 into the system through the use of a vendor access module (“VAM”) 130. The VAM 130 provides an interface into the order information that the IOCM system 108 maintains in its order information data store 112. According to one embodiment of the invention, the VAM 130 is a web-based interface into this information. For example, the VAM 130 may be implemented using ColdFusion, Active Server Pages, Java Server Pages, PHP, etc. The web-based interface may be implemented according to Open Database Connectivity (“ODBC”), allowing multiple vendors 104 to log on using the VAM 130 and access orders, download orders, enter tracking information and perform other various functions necessary to complete their portion of order fulfillment.

An administrator sets up a merchant name and password within the VAM 130 for each vendor 104. Once a vendor 104 logs into the VAM 130, the module 130 presents the vendor 104 with a screen that notes the number of new orders that exist, the number of back orders that exist, how many outstanding tracking requests exist, etc. They may also use the VAM 130 to review account information and products from the vendor 104 that the merchant carries in one or more storefronts 102 that the IOCM system 108 is managing.

By interfacing with the information in the order information data store 112 using the VAM 130, the vendor 104 is effectively and indirectly communicating with the customer. For example, by entering a tracking number associated with a given order into the data store, e.g., the vendor 104 updates the record for a given order, the order management module 110 generates a flag indicating that it must send an email to the customer noting the tracking number, preferably including information regarding how to use the tracking number. The language used, however, is developed by the merchant, which allows the IOCM system 108 to control the substantive content that the vendor 104 is transmitting to a customer.

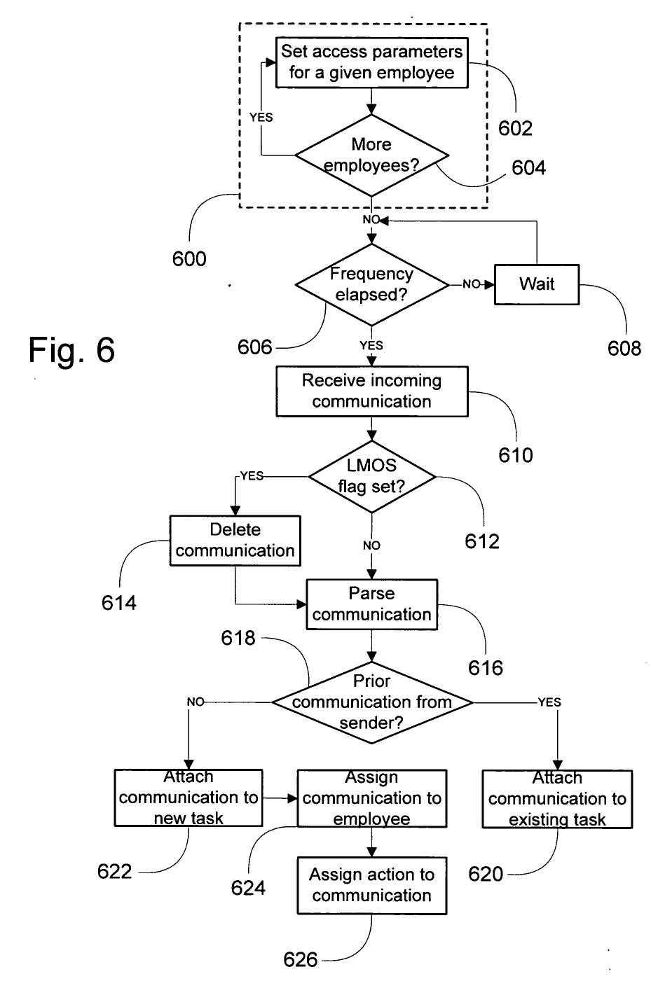

To provide complete order management solutions the IOCM system tracks both outbound and incoming communications, which may be accomplished according to the method illustrated ay FIG. 6. The process of communication tracking considers two issues: how to acquire a given communication and how to parse the given communication, e.g., how to associate communications with orders or previous communications. The IOCM system associates communications and orders through the use of a task structure. Accordingly, the system may implement one or more of the following data structures: mailtrack, tasks, employees and companyinfo, which, according to embodiments of the invention, are structured in tables in a relational database. Appendix E presents exemplary table structures for tables in a relational database for the mailtrack, tasks and companyinfo data structures.

The merchant creates “actions” within the IOCM system, which the system may associate with incoming communications. For example, actions may include, but are not limited to, customer refund request, unsatisfied customer complaint, vendor information to be updated, or any other action that a customer may request of the merchant. The merchant selects a default action from the existing actions, which is set as the default actions for created tasks, step 602. Where the merchant makes use of multiple employees, the merchant selects a default action for each employee that is used when tasks are created for a given employee, step 604. For example, where a given employee's default action is set as “return request” and the system receives an email sent to the given employee that does not attach to an existing task, a new task is created with the “return request” action pre-selected.

The system may utilize a clock or similar timer to check for the expiration of a frequency period, e.g., every thirty (30) minutes, step 606. Where the frequency period has not elapsed, step 606, the system may enter a wait state until the expiration of the frequency period, step 608. Upon expiration of the frequency period, the system receives any incoming communications, step 610. The IOCM system may employ its email access module 126 to accomplish the acquisition of incoming communications. When invoked, the module checks all of the employee communication accounts, plus the main company account, importing these communications into the mailtrack table and a notation indicating that the communication was inbound.

For a given inbound communication that the system receives, step 610, a check is performed to determine if a leave message on server (“LMOS”) is set, step 612. An LMOS flag notes whether or not a given communication is to be left on the server or retrieved for local storage and deleted from the server. For example, where the communication is email, a client retrieving an email from the email server may result in the removal of the email from the server. By selecting the LMOS option, a merchant may leave the email message on the server so that other clients may connect to the server and retrieve a copy of the email, which is advantageous when multiple clients must have access to a given communication. Where the LMOS flag is set, step 612, the communication is deleted from the server, step 614.

When parsing an incoming communication, step 616, the system may identify the “from” address identified within the communication, and perform a check to determine whether the system maintains a prior communication from the sender, step 618. Where the system has previously identified the “from” information for a communication, step 618, the system attaches the communication (imported into the mailtrack data structure) to the last task that was attached to the address, step 620. Where no task exists that is attached to the address, step 618, the system creates a new task to which it attaches the communication, step 622. According to one embodiment, the communication's subject line is also searched to determine if an order number is present.

When importing communications, which are not limited to electronic mail and may comprise any digital communication from a vendor or customer, the email access module 126 may look at other records in the mailtrack data structure to see whether communications from the current address exist in the structure, step 618, and if present, retrieves the unique task ID to which the communication is attached, step 620. That task ID is assigned to the new communication and the associated status is changed to “In Progress” from what might have previously been “Complete.” If there is no record within the mailtrack structure with the address of the current communication, step 618, then the module creates a new task with a status of “New,” step 622, and an action matching the default action for the employee to which the communication is assigned, steps 624 and 626. The mailtrack record, which was created from the email received, may be attached to the task in the usual manner. If an email is received from a particular pop3 account, the task to which it is attached may be automatically connected to the related employee.

Returning again to FIG. 1, the IOCM system 108 has thus far been described in relation to the order management functions that the order management module 110 provides. The system and method of the present invention, however, also comprise channel management functionality via a channel management module 132. Continuing with FIG. 1, the channel management module 132 allows a merchant or other user of the IOCM system 108 to configure data feeds containing product information, e.g., from a merchant's electronic product catalog, to online retail aggregators such as Froogle, MySimon, or other aggregators of items made available through electronic storefronts.

The channel management 132 module allows the merchant to specify what, how, where and when to provide information. The channel management module 132, once configured, is self-maintaining, and will perform without supervision or maintenance other than monitoring of log files by the merchant. According to one embodiment of the invention, the channel management module 132 utilizes a number of related tables in a relational database to structure and store the channel feed information, e.g., product and channel information data store 134. Appendix D presents an exemplary table structure for storing channel feed information.

The channel management module 132 transports the resultant channel feed according to the protocol that the channel 106 requires. When the channel 106 receives the channel feed, the channel 106 incorporates the information into the product aggregation services that it provides. For each channel feed that it transmits, the channel management module 132 writes an entry into a channel feed log that that IOCM system maintains in a data store 134, which may be part of any other data store that the IOCM system maintains. The channel management module 132 may also write additional data regarding the transmission, for example, success, failure, and any relevant error codes or indicia.

The following examples illustrate the information that may comprise a channel feed. One example of a channel feed might be directed to Froogle. Assume that Froogle allows its customers to transmit files that contain comma-separated information to a specific FTP server. The channel feed to Froogle may comprise product information such as:
Product SKU or Model
Product Name
Product Price
Product URL
Image URL (Thumbnail)
Product Manufacturer
Product Description (NO HTML)
   To allow a channel such as Froogle to process the information in the channel feed, the channel feed must include header information, which the merchant provides, to allow the channel to parse the information in the channel feed. For example, the information contained in the exemplary channel feed identified above also includes the following header information:
product ID
Product Name
Price
Product URL
Image URL
Manufacturer
Product Description
   The channel management module packages this information according to a comma separated data file and transmits the channel feed and header information to the Froogle FTP site. The module executes the transmission according to the file transfer protocol, and further according to the schedule or frequency set by the merchant.

Another example of a channel feed might be directed to Shopping.com. Assume that Shopping.com allows merchants to transmit XML product information to a specific URL or address. The channel feed to Shopping.com may comprise product information such as:
Product SKU or Model
ISBN (leave blank if not applicable)
Product Name
Product Price
Product URL
Image URL (Thumbnail)
Image URL (Full Size)
Product Manufacturer
Product Description (NO HTML)
Product Description (with HTML)
   Also, the channel feed also comprises header information that identifies the structure of the product information in the channel feed, such as:
SKU
ISBN
Name
Price
Product URL
Small URL
Large URL
Manufacturer
Text Description
HTML Description
   The channel management module 132 packages this information according to an XML data file and transmits the XML data file to the Shopping.com WSDL location. The module executes the transmission according to the protocol that the Shopping.com web service defines, and further according to the schedule or frequency set by the merchant.

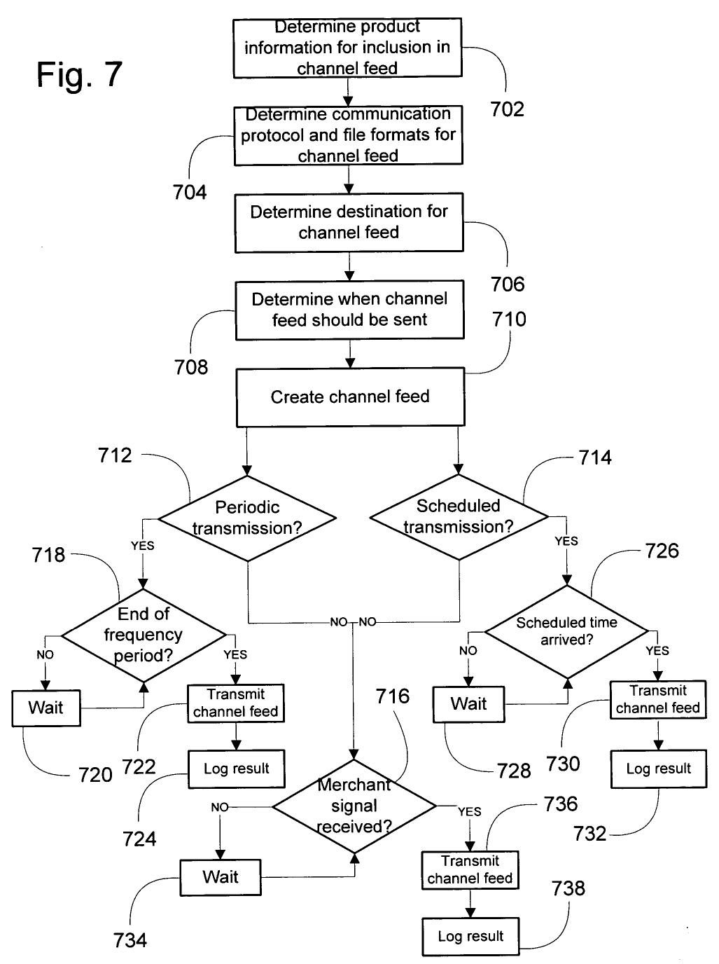

One embodiment of a method for providing automated channel management is illustrated in FIG. 7. To allow automated channel management, the merchant must provide a number of pieces of information to the channel management module regarding the products, which the channel management module stores in a data store. According to one embodiment, the data store may be the same or a different data store the system uses for storage of information regarding order management. The merchant must identify the product information that is to be included within the channel feed (“what”), step 702. For example, where a relational database stores the product information, the merchant may provide a query to specify the records that the system is to include in the channel feed. The merchant also specifies the communications protocols (“how”) and file formats for transmission of the information, step 704, as well as a destination address (“where”), step 706. Finally, the channel management module may be provided with a time or frequency according to which transmission of a given channel feed is to occur (“when”), step 708.

According to one embodiment, each channel feed comprises a “group id” that is specified as a parameter to a scheduled task. When operating in a Microsoft Windows environment, the merchant specifies the group ID in a scheduled task. For example, the channel feeds identified by group id 1 may be scheduled to run daily, whereas the channel feeds identified by group id 2 may be scheduled to run weekly. Other scheduling systems, such as cron, are contemplated as falling within the scope of the invention. Furthermore, it should be noted that the channel management module does not require use of groups of channel feeds, and may transmit individual channel feeds.

When the channel management module determines that it must transmit one or more feeds to one or more channels, the module gathers all necessary information for each channel feed, including, but not limited to, channel name, stored query, channel location, transfer protocol, file format, fields and field names regarding the products from the data store. With this information, the module creates the channel feed, step 710, which may be a data file, according to the appropriate file format as determined by information regarding the channel within the data store. The information that populates the channel feed may be acquired by running the query on the data store to retrieve records of information, and includes any fields that have been included in the query. The required fields may be labeled, for example, by providing headers or XML labels in the case of XML data, which may also include using the names specified by the merchant using the channel feed interface described in greater detail herein. The channel management module may also apply compression techniques to the channel feed as is well known to those of skill in the art.

Transmission may be made periodically, step 712, according to a schedule, step 714, or in response to a merchant transmission signal, step 716. The transmission of the notification may be according to a frequency, step 712, which causes the order management module to check for the end of the frequency period, step 718. Where the frequency period has not ended, step 718, the system enters a wait state, step 720, and continues to check for the end of the frequency period, step 718. When the frequency period ends, the channel management module sends the channel feed to the indicated channel, step 722, and logs the result, step 724.

Alternatively, or in conjunction with transmitting according to a frequency, the transmission of the channel feed may be sent according to a schedule, step 714, which causes the channel management module to check for the occurrence of the scheduled time, step 726. It should be noted to those of skill in the art that a schedule and schedule time may be set according to any combination of date and time including, but not limited to, day of the week, every day at a specified time, on a given day of the month, etc. According to one embodiment, the channel management module is running in a UNIX environment and may utilize the “cron” tool to schedule a signal to the system to generate the notifications. Similarly, in a Microsoft Windows environment, the merchant may set a Microsoft scheduled event to signal the generation of the notifications. Where the scheduled time has not arrived, the system enters a wait state, step 728, and continues to check for the arrival of the scheduled time, step 726. When the scheduled time arrives, the channel management module sends the channel feed to the indicated channel, step 730, and logs the result, step 732.

The merchant may also manually signal transmission of a given channel feed, step 716. Where the merchant has not set a frequency or schedule by which to transmit a given channel feed, steps 712 and 714, respectively, and a merchant transmission signal is not received, step 716, the system enters a wait state, step 734. When the channel management module receives the merchant transmission signal, step 716, the channel management module sends the channel feed to the indicated channel, step 736, and logs the result, step 738.

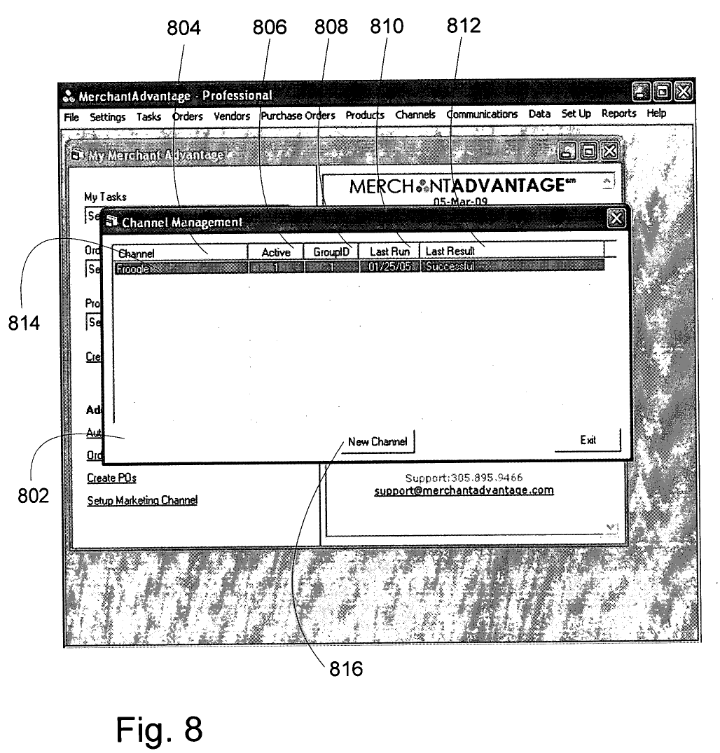

The channel management module provides an interface to configure the various channel feeds and the information that each comprises. According to one embodiment, the interface is a graphical interface. The channel management module presents an initial interface, one embodiment of which is illustrated in FIG. 8, which presents information regarding existing channels 802. The existing channel interface 802 presents information regarding the existing channels including, but not limited to, the channel name 804, a flag indicating whether or not the channel is active 806, a group identifier 808, the last time the channel feed was transmitted 810, and the results of the last transmission 812. Using the interface, a merchant may select an existing channel feed 814 to modify information regarding the channel feed or select a “new channel” control 816 to create a new channel feed.

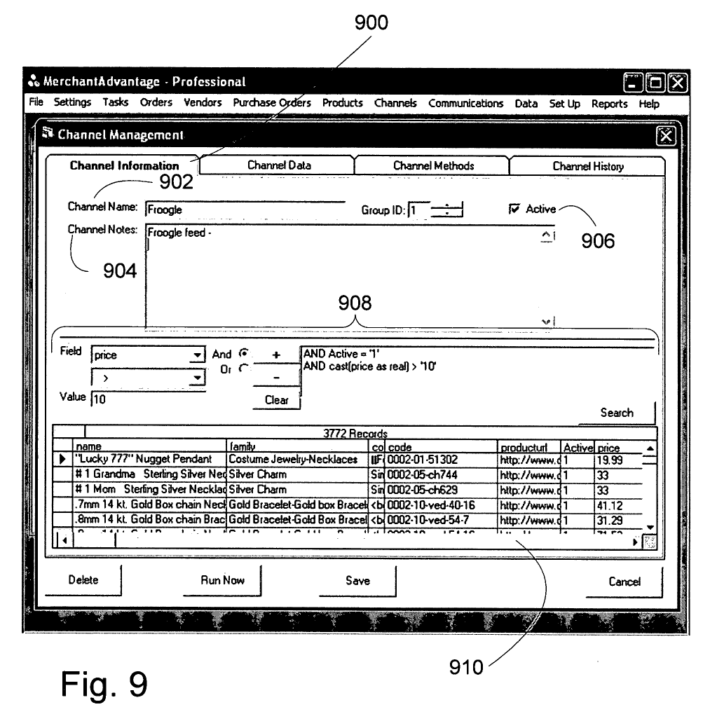

Regardless of whether the merchant selects an existing channel feed for modification or elects to create a new feed, the channel management module presents a tabbed interface that presents information regarding different aspects of a given channel feed. As illustrated in FIG. 9, the first tab may comprise general information regarding the channel feed 900. For example, the interface presents the name of the channel feed 902 and free text notes regarding the channel feed 904. A check box 906 allows for activation and deactivation of the channel feed, which sets a flag in the channel feed information located in a data store that the IOCM system maintains. Where the channel management module maintains the channel feed information in a relational database, this tab provides controls that allow the merchant to specify a SQL query 908 that the module uses to retrieve product information from an information store that the IOCM system maintains. Other types of queries, as are appropriate for achieving access to other types of data stores known to those of skill in the art are contemplated as falling within the scope of the present invention. The interface also presents the set of product information records 910 that fall within the scope of the query that the merchant specifies 408.

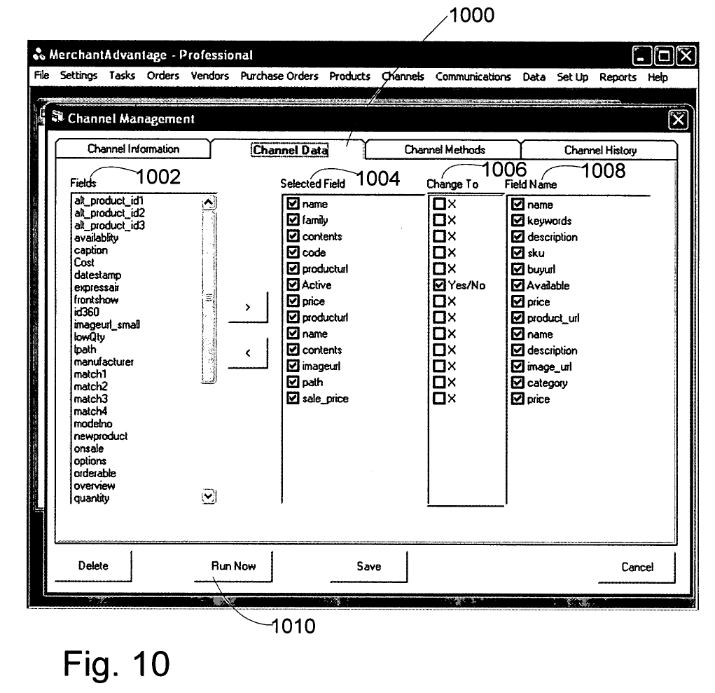

As illustrated in FIG. 10, the second tab 1000 may comprise formatting information regarding the channel feed. Along a left side of the interface is a listing 1002 of all fields of product information that exist in the system's data store, e.g., in a products table. As the merchant selects fields, each field appears in a selected field list 1004. Disparate data stores may employ different techniques for noting the selection or non-selection of a given piece of information in a given data store. For example, a first system may use “Y” and “N” to denote the selection or non-selection of information, whereas a second system may use the values “1” and “0.” Using the change to list 1006, a merchant may select to convert a field expressed in a first data source in terms of “1” and “0” to “Y” and “N,” or vice versa, for selected fields during the channel feed process. Additionally, the channel feed may contain information that denotes the organization of information comprising a channel feed. This information allows the destination channel to properly place information comprising the channel feed into the destination data source. Using the filed name column 1008, the merchant may enter the name of a given field according to the manner in which the destination channel wishes to receive the information. Along a lower portion of the interface is a “run now” control 1010 that instructs the channel management module to package the channel feed information and transmit the information to a destination application, e.g., executes the channel feed.

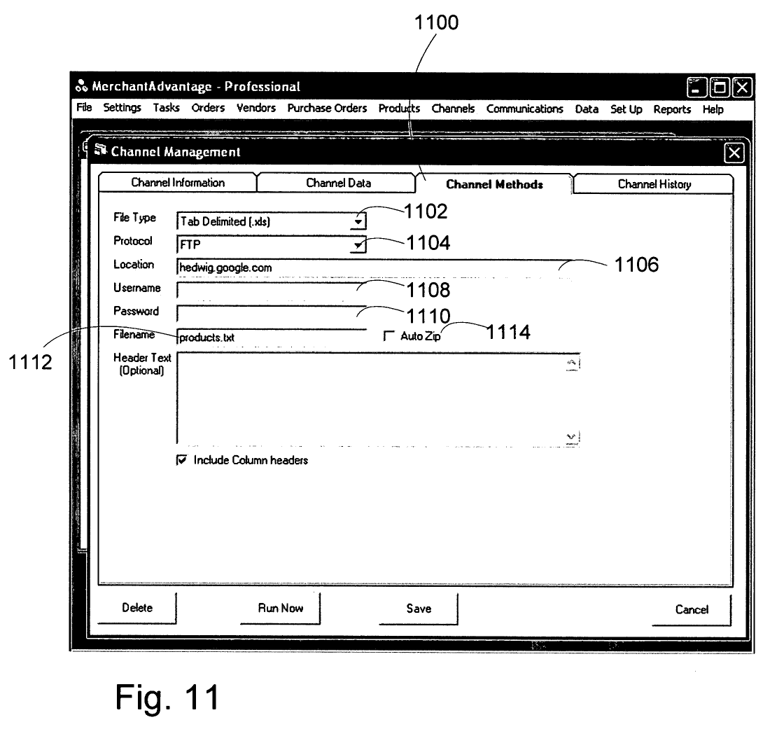

Turning to FIG. 11, the third tab may comprise transmission information regarding the channel feed 1100. A drop down control 1102 allows the merchant to select the file type that the module uses to format the channel feed, e.g., tab delimited data, comma separated, XML, Web Services/SOAP, and other industry standards known to those of skill in the art. Similarly, the interface provides a drop down control 1104 that allows the merchant to select the protocol that the module uses to transfer the channel feed, e.g., FTP, email, etc. A location text entry control 1106 allows the merchant to specify the transmission destination for the channel feed. Similarly, the interface provides text entry controls that allow the merchant to specify a username 1108, password 1110 and a filename 1112, which is the name of the file that is to be created. An “auto-zip” control 1114 instructs the module to compress the channel feed prior to transmission.

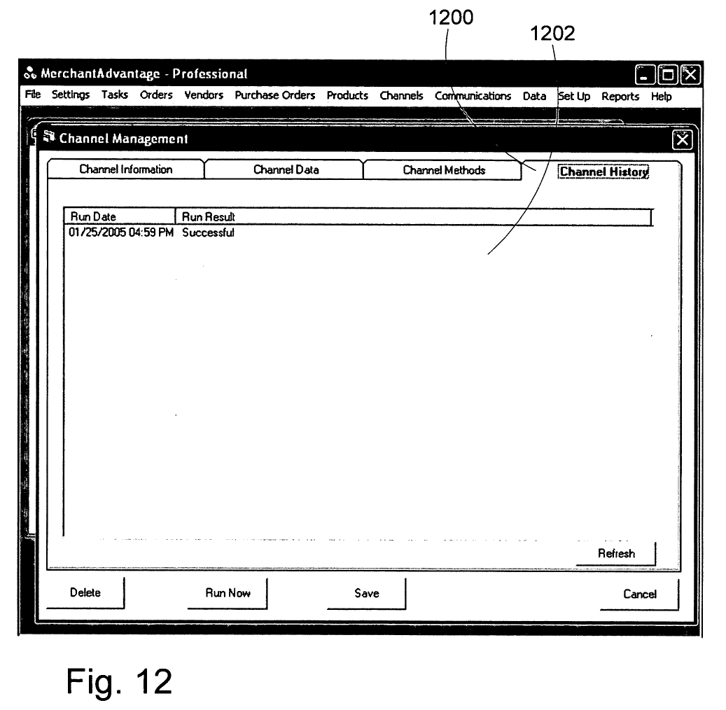

The fourth tab, illustrated in FIG. 12, may comprise channel feed history or log information 1200. Each time the channel management module transmits a channel feed to a destination, the module writes log information to the channel feed log. This tab 1200 presents a view 1202 of the information that the module has written to the log regarding the past transmission of channel feeds.

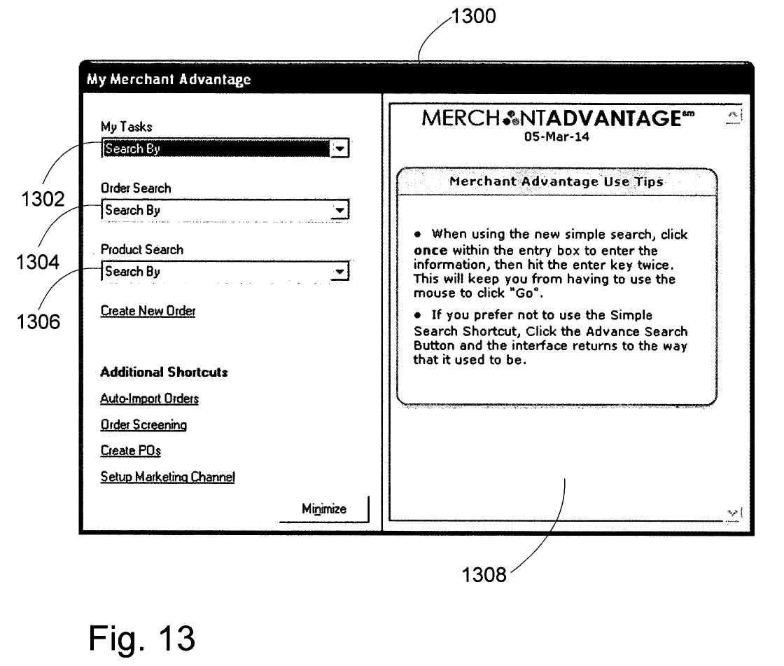

One embodiment of an interface to the IOCM system is presented in FIG. 13. This interface 1300 encapsulates controls for accessing major functions in a single interface. According to this embodiment, when a merchant instantiates the application, the interface of FIG. 13 is the default interface. Alternatively, the interface 1300 may be manually invoked by the merchant, e.g., by selection of a control that a disparate interface presents. The left side of the interface presents shortcuts to functions including, but not limited to, task search 1302, order search 1304 and products search 1306. When invoked, these dropdowns instruct the system to launch the appropriate control. On the right side of the interface is a browser 1308 showing a predetermined web page, including, but not limited to, tips and tricks, release notes, expected fixes, and some marketing information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

### APPENDIX A

### Field Specifications for Order Processing Table

Order
Customer Name (Billing Name)
AVS
OrderID
Order Date
TBC
Items
V-Ack (not shown individually, but used to see if all items on an order have been acknowledged)
Rateimpact
iid
idescription
Invoicetext

Impact

APPENDIX B
SCORE CALCULATION DATA STRUCTURE

| id | description | invoicetext | impact | created |
|---|---|---|---|---|
| 1 | Billing Name is Different than | Bill Name Not Ship | 3 | Jan. 27, 2005 |
| | Shipping Name | Name | | 15:13 |
| 2 | Billing Address1 is Different from | Bill Address Not | 12 | Jan. 27, 2005 |
| | Shipping Address1 | Ship Address | | 15:13 |
| 3 | Country is NOT U.S. | Non US Country | 10 | Jan. 27, 2005 |
| | | | | 15:13 |
| 4 | Email Address Contains hotmail, | Contact Email is | 3 | Jan. 27, 2005 |
| | yahoo or netscape | Free account | | 15:14 |
| 5 | Email Address is not aol, comcast, | Not Known Paid | 2 | Jan. 27, 2005 |
| | netzero, bellsouth, sbcglobal, msn | Email | | 15:15 |
| 6 | AVS Address is Bad | Bad CC Address | 7 | Jan. 27, 2005 |
| | | | | 15:15 |
| 7 | AVS zip is Bad | Bad CC Zip | 8 | Jan. 27, 2005 |
| | | | | 15:15 |
| 8 | Order Time is After midnight, and | Order during | 2 | Jan. 27, 2005 |
| | before 5 am est | obscure hours | | 15:16 |
| 9 | More than one line item excluding | More than one line | 2 | Jan. 27, 2005 |
| | tax and shipping | item | | 15:16 |
| 10 | More than 2 line items excluding tax | More than two line | 3 | Jan. 27, 2005 |
| | and shipping | items | | 15:17 |
| 11 | More than 4 line items excluding tax | More than four line | 5 | Jan. 27, 2005 |
| | and shipping | items | | 15:17 |
| 12 | Order total is greater than $50 | Order Exceeds $50 | 1 | Jan. 27, 2005 |
| | | | | 16:47 |
| 13 | Order total is greater than $250 | Order Exceeds | 4 | Jan. 27, 2005 |
| | | $250 | | 16:48 |
| 14 | Order total is greater than $250 | Order Exceeds | 5 | Jan. 27, 2005 |
| | | $500 | | 16:48 |

### APPENDIX C

### Field Specifications for Orders, Items and Options Tables

Orders

| Name | Type | Size | Nulls | Description |
|---|---|---|---|---|
| orderuid | int | 4 | 0 | ID - Unique Autonumbering |
| OrderID | varchar | 255 | 1 | Order Number from Store Front |
| [date] | varchar | 25 | 1 | Date of Import |
| ShipName | varchar | 255 | 1 | Ship to name on import |
| ShipAddress1 | varchar | 255 | 1 | Ship to address |
| ShipAddress2 | varchar | 255 | 1 | Ship to address line 2 |
| ShipCity | varchar | 255 | 1 | Ship to city |
| ShipState | varchar | 255 | 1 | Ship to State |
| ShipCountry | varchar | 255 | 1 | Ship to Country |
| ShipZip | varchar | 255 | 1 | Ship to Zip |
| ShipPhone | varchar | 255 | 1 | Ship to Phone |
| BillName | varchar | 255 | 1 | Bill to Name |
| BillAddress1 | varchar | 255 | 1 | Bill to Address |
| BillAddress2 | varchar | 255 | 1 | Bill to Address line 2 |
| BillCity | varchar | 255 | 1 | Bill to city |
| BillState | varchar | 255 | 1 | bill to state |
| BillCountry | varchar | 255 | 1 | Bill to country |
| BillZip | varchar | 255 | 1 | Bill to Zip |
| BillPhone | varchar | 255 | 1 | Bill to Phone |
| Email | varchar | 255 | 1 | Email address on order |
| IPAddress | varchar | 255 | 1 | IP address of Consumer at time of |
| | | | | purchase |
| ReferringPage | varchar | 255 | 1 | Referring Page |
| EntryPoint | varchar | 255 | 1 | Entry point of consumer to storefront |
| Shipping | varchar | 255 | 1 | Shipping information |
| Payment_Method | varchar | 255 | 1 | Payment method |
| CardNumber | varchar | 255 | 1 | Card Number |
| CardExpiry | varchar | 255 | 1 | Card Expiration |
| Comments | text | 16 | 1 | Order Comments (appendable within |
| | | | | MA system |
| Total | smallmoney | 4 | 1 | Order Total |
| LinkFrom | varchar | 255 | 1 | Consumers link from |
| Warning | varchar | 255 | 1 | Warning on orders |
| Partner | varchar | 3 | 1 | Storefront |
| authcode | varchar | 50 | 1 | Card authorization number |
| avscode | char | 2 | 1 | AVS as supplied by Storefront |
| cardtype | varchar | 50 | 1 | Card Type |
| tbc | tinyint | 1 | 1 | Flag noting if card has been charged (To |
| | | | | Be Charged) |
| cvv2 | varchar | 5 | 1 | CVV2 card security number |

Items

| Name | Type | Size | Nulls | Description |
|---|---|---|---|---|
| ID | int | 4 | 0 | ID - Autonumbering Unique |
| orderdate | varchar | 50 | 1 | Date of original order |
| cost | smallmoney | 4 | 1 | Cost (brought over from Products table) |
| cancelcode | varchar | 13 | 1 | CancelCode or item status |
| podate | datetime | 8 | 1 | PO Date created during Daily Create |
| | | | | process |
| Order_ID | varchar | 255 | 0 | Link to order |
| Line_ID | varchar | 255 | 1 | Assigned line number within order |
| Product_ID | varchar | 255 | 1 | * |
| Product_Code | varchar | 255 | 1 | Link to product |
| Quantity | int | 4 | 1 | Quantity ordered within this order |
| Unit_Price | varchar | 50 | 1 | Price charged for this order |
| PO | varchar | 35 | 1 | PO created during Daily Create Process |
| VendorCode | varchar | 4 | 1 | Link to Vendor |
| expship | varchar | 50 | 1 | Expected Ship (if backordered) |
| vendoraccept | varchar | 1 | 1 | Vendor Accept Flag |
| dodate | datetime | 8 | 1 | Date next email is to be sent |
| dodone | char | 1 | 1 | 0 if not yet sent, 1 if email has been sent |
| trackreq | char | 1 | 1 | Request product tracking informaiton from |
| | | | | Vendor |
| trackingnumber | varchar | 45 | 1 | Tracking number |
| vcan | char | 6 | 1 | Send Notification to original vendor of |
| | | | | cancelation |
| acceptdate | datetime | 8 | 1 | Date of vendor acceptance |
| Partner | varchar | 3 | 1 | StoreFront from which this order was |
| | | | | received |
| Linetotal | smallmoney | 4 | 1 | Total online within order |
| shippedmeth | int | 4 | 1 | Shipping method |

Options

| | | | Allow | |
|---|---|---|---|---|
| Name | Type | Length | Nulls | Description |
| UID | int | 4 | 0 | ID - Unique Autonumbering |
| datestamp | datetime | 8 | 1 | Original Date of entry |
| quantity | int | 4 | 1 | quantity on hand |
| code | varchar | 100 | 1 | Product code (vendor-modelno) |
| modelno | varchar | 100 | 1 | Model Number, or SKU |
| name | varchar | 500 | 1 | Product Name |
| price | varchar | 100 | 1 | Retail Price |
| sale_price | varchar | 100 | 1 | Price, if on sale |
| Cost | varchar | 100 | 1 | Wholesale cost |
| truecost | money | 8 | 1 | Cost from distribution or from the |
| | | | | manufacturer |
| caption | text | 16 | 1 | Full description of this product, may |
| | | | | include HTML |
| contents | text | 16 | 1 | Contents - Caption without HTML |
| path | varchar | 150 | 1 | Path, or menu structure |
| ypath | varchar | 150 | 1 | Location for this product within Yahoo's |
| | | | | menu structure |
| family | varchar | 150 | 1 | N/A |
| options | varchar | 5000 | 1 | Options applicable to this product |
| ship_weight | decimal | 9 | 1 | Ship Weight or Shipping Multiplier |
| Vendor | varchar | 4 | 1 | Main Vendor which provides this product |
| availablity | varchar | 255 | 1 | Availability |
| manufacturer | varchar | 100 | 1 | Manufacturer of this product |
| producturl | varchar | 255 | 1 | URL of this product |
| imageurl | varchar | 255 | 1 | URL of a full size image of this product |
| imageurl_small | varchar | 50 | 1 | URL of a thumbnail image of this product |
| Active | tinyint | 1 | 1 | Active (1, 0) |
| orderable | varchar | 100 | 1 | Is this product orderable |
| lowQty | smallint | 2 | 1 | N/A |
| reorderQty | smallint | 2 | 1 | N/A |

### APPENDIX D

### Exemplary Tables for Support of Channel Feeds

Channels

| | |
|---|---|
| Cuid | Int Unique Autonumber Primary Key No Nulls |
| Name | Varchar 255 No Nulls |
| Channelnotes | Text |
| StoredQuery | VarChar 3000 No Nulls |
| Uname | VarChar 25 |
| Pword | VarChar 25 |
| Location | Varchar 1000 |
| Filename | Varchar 25 |
| Protocol | Varchar 100 |
| FileFormat | Varchar 100 |
| GroupID | TinyInt |
| Autozip | Tinyint Default to 0 |
| Active | TinyInt Default to 1 |

Channelfields

| Cuid | Int link to Channels |
|---|---|
| Cfuid | Int Unique Autonumber Primary Key No Nulls |
| Fieldname | VarChar 50 No Nulls(The name expected by Channel) |
| Fieldvalue | VarChar 50 No Nulls (The data field to use) |

ChannelLog

| Cuid | Int link to Channels |
|---|---|
| Cluid | Int Unique Autonumber Primary Key No Nulls |
| Occurance | DataTime GetDate( ) |
| Errorcode | VarChar 255 Text explaining errors which have occurred |

APPENDIX E
EXEMPLARY TABLE FOR SUPPORTING INBOUND
COMMUNICATION TRACKING

| | |
|---|---|
| MailTrack | |
| Edirection | tinyint Default 0 = outbound 1 = inbound |
| Employees | |
| Daction | Int link to actions |
| Emailuname | varchar 50 |
| Emailpword | varchar 50 |
| Lmos | tinyint |
| Tasks (todo) | |
| StartDate | smalldatetime(default getdate( ))Controls for date and |
| | time |
| EndDate | smalldatetime (no default) Controls for date and time |
| CompanyInfo | |
| P3server | varchar 50 |
| P3defaultemail | varchar 50 |
| P3duname | varchar50 |
| P3dpword | varchar 50 |

We claim:

1. A method for managing an order for a product from a customer in a computerized order management system, the method comprising:
receiving over a data network one or more orders for associated products from one or more customers for storage in a data store;
selecting a given order from a given customer to a merchant from among the received one or more orders;
setting a status code for the given order;
setting a status code for one or more items associated with the given order; and
providing the product associated with the given order to the given customer on the basis of the status code.

2. The method of claim 1, wherein receiving over a data network one or more orders comprises receiving by an integrated order and channel management system.

3. The method of claim 2 wherein receiving over a data network comprises receiving over the Internet.

4. The method of claim 1 wherein providing comprises shipping the product.

5. The method of claim 1 wherein providing comprises transmitting the product.

6. The method of claim 5 wherein transmitting comprises transmitting over the Internet.

7. The method of claim 1 comprising:
applying a merchant created filer; and
presenting one or more orders from the data store that satisfy the filter.

8. The method of claim 1 comprising:
receiving an update to a given order in the data store by a vendor of the associated product;
storing the update to the given order in the data store; and
presenting the updated given order to the merchant.

9. The method of claim 8 comprising:
generating, by the merchant, a communication to a customer that placed the given order; and
transmitting the communication to the customer.

10. The method of claim 1 wherein setting the status code for one or more items comprises setting on the basis of the status code of the order with which the one or more items are associated.

11. The method of claim 1 wherein setting the status code for one or more items comprises setting independent of the status code of the order with which the one or more items are associated.

12. The method of claim 1, wherein setting the status code for the given order comprises determining the status code on the basis of an order score.

13. The method of claim 12 wherein determining the order score comprises:
retrieving a score calculation data structure comprising one or more score criterion;
determining, for the one or more score criterion in the score calculation data structure, the presence of a given score criterion in the given order; and
increasing the order score on the basis of the presence of the one or more score criterion in the given order.

14. A method for managing a product data feed for delivery to an electronic distribution channel, the method comprising:
determining product information for inclusion in a channel feed to the electronic distribution channel;
determining one or more characteristics for the channel feed;
generating the channel feed for the product on the basis of the one or more characteristics for the channel feed; and
determining when to transmit the channel feed to the electronic distribution channel.

15. The method of claim 14 wherein determining the one or more characteristics comprises determining a protocol for transmission of the channel feed.

16. The method of claim 15 determining the one or more characteristics comprises selecting a file transmission protocol for transmission of the channel feed.

17. The method of claim 14 wherein determining the one or more characteristics comprises determining a file format for transmission of the channel feed.

18. The method of claim 14 wherein determining the one or more characteristics comprises determining a destination for transmission of the channel feed.

19. The method of claim 14 comprising transmitting the channel feed to the electronic distribution channel according to the one or more characteristics.

20. The method of claim 19 wherein transmitting the channel feed comprises transmitting according to a frequency.

21. The method of claim 19 wherein transmitting the channel feed comprises transmitting according to a schedule.

22. The method of claim 19 wherein transmitting the channel feed comprises transmitting according to a merchant transmission signal.

23. The method of claim 19 wherein transmitting the channel feed comprises transmitting to Froogle.

24. The method of claim 1 wherein transmitting the channel feed comprises transmitting to MySimon.

25. The method of claim 14 wherein generating the channel feed comprises generating an XML file for the product on the basis of the one or more characteristics.

26. The method of claim 14 wherein generating the channel feed comprises querying a data store to retrieve the product information and the one or more characteristics.

27. The method of claim 14 comprising compressing the channel feed.
